(19) United States
(12) Patent Application Publication
(10) Pub. No.: US 2022/0389218 A1
(43) Pub. Date: Dec. 8, 2022

(54) POLYMER COMPOSITION WITH IMPROVED CRYSTALLIZATION SPEED, AND METHOD FOR PREPARING SAME

(71) Applicant: HANWHA SOLUTIONS CORPORATION, Seoul (KR)

(72) Inventors: Hana KANG, Daejeon (KR); Shinje CHO, Daejeon (KR); JeongMin LEE, Daejeon (KR); Myungchul PARK, Daejeon (KR)

(21) Appl. No.: 17/773,443

(22) PCT Filed: Jul. 2, 2020
(86) PCT No.: PCT/KR2020/008656

§ 371 Date: Apr. 29, 2022

(30) Foreign Application Priority Data
Oct. 31, 2019 (KR) 10-2019-0137952

(51) Int. Cl. C08L 71/00; C08J 3/20

(52) U.S. Cl. CPC C08L 71/00; C08J 3/203; C08L 2205/12; C08L 2205/24; C08J 2371/10

(57) ABSTRACT

The present invention relates to a novel polyaryletherketone (PAEK) polymer composition with a significantly increased crystallization rate, and preferably, to a polyetherketoneketone (PEKK) polymer composition. According to the present invention, there is provided a polymer composition including a liquid crystal polymer (LCP), an inorganic nucleating agent, a reinforcing agent, and a filler in polyaryletherketone (PAEK). Therefore, the present invention provides an effect of improving a crystallization rate of the polymer composition and improving molding processability, thereby improving productivity, shape, dimensional stability, or the like of products.

### TECHNICAL FIELD

The present invention relates to a novel polyaryletherketone (PAEK) polymer composition with a significantly increased crystallization rate (speed), and preferably, to a composition including a polyetherketoneketone (PEKK) polymer. In particular, a PEKK resin includes a liquid crystal polymer (LCP) so as to promote crystal nucleation and significantly improve a crystallization rate of a PEKK polymer composition.

### BACKGROUND ART

Polyarylketoneketone is a generic term for already known industrial resins, and the types of polyarylketoneketone include polyetherketone, polyetheretherketone, polyetherketoneketone, and a copolymer in which polyetherketone and polyetherketoneketone are partially mixed.

Among them, polyarylketoneketone is an ultra-high performance plastic that has high heat resistance and excellent mechanical strength and is thus widely used in automobile, aerospace, energy, and electrical and electronic fields.

In addition, among various polyarylketoneketone (PAEK)-based polymers, polyetherketoneketone (PEKK) represented by the following chemical formula is particularly high in heat resistance and excellent in strength and is thus widely used as engineering plastics. Engineering plastics are used in the fields of automobiles, aircraft, electrical and electronic equipment, machines, or the like, and their field of applications is gradually expanding.

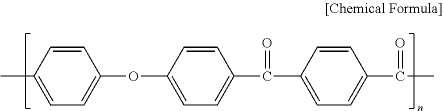

As the field of applications of engineering plastics is expanding, the usage environment thereof becomes more severe. Therefore, there is a need for polyetherketoneketone compounds that exhibit more improved physical properties. However, polyetherketoneketone tends to show a low crystallization rate due to the influence of isophthaloyl moiety. Due to this, a molding time increases and there is a difficulty in processing. Therefore, research to improve physical properties is actively in progress.

For example, Korean Patent Publication No. 10-1855054 discloses a composition based on polyetheretherketone with improved properties, wherein a crystallization rate of a resin composition can be controlled by adjusting the ratio of terephthalic and isophthalic units. In particular, Korean Patent Publication No. 10-1855054 has a technical feature of inducing optimum yield point and elongation, etc. while controlling a crystallization rate by using a specific composition ratio.

In addition, Chinese Patent Publication No. 10-7880522 discloses a polyetherketoneketone composite material containing a crystal whisker, wherein a polyetherketoneketone resin contains fluorination, inorganic crystal whisker, coupling agent, etc. so as to maintain inherent properties of the polyetherketoneketone resin itself, improve physical properties such as excellent high temperature resistance and flame retardancy, and furthermore, improve shear strength and impact strength of parts and increase wear resistance. Although the point of improving various physical properties is disclosed, there is some limitation in that the point of improving the crystallization rate is not disclosed.

Lastly, US Patent Registration No. 10-32542 relates to a foamed composition containing a polymer, talc, and derivatives thereof, wherein polyetherketoneketone and liquid crystal polymer can be included as the type of polymer, thereby securing insulation. However, there is some limitation in that US patent does not disclose the improvement of the crystallization rate.

Various methods have been developed to improve the physical properties of polyetherketoneketone as described above, but there is still an urgent need to develop polyaryletherketone (PAEK) or polyetherketoneketone (PEKK) polymer-related technologies for improving a crystallization rate.

(Patent Literature 1) Korean Patent Registration No. 10-1855054 (2017 Jun. 8)

(Patent Literature 2) Chinese Patent Registration No. 10-7880522 (2018 Apr. 6)

(Patent Literature 3) US Patent Registration No. 10-32542 (2016 May 12)

### DESCRIPTION OF EMBODIMENTS

### Technical Problem

The present invention aims to solve the above-described problems.

An object of the present invention is to provide a polyaryletherketone (PAEK) with an improved crystallization rate, and preferably, to provide a polyetherketoneketone (PEKK) polymer composition with an improved crystallization rate.

An object of the present invention is to provide a polymer composition with an improved crystallization rate, thereby improving molding processability and further improving productivity, shape, dimensional stability, or the like of products.

In addition, the present invention aims to improve crystallinity, and thus, improve mechanical properties and heat resistance of the polymer composition.

Therefore, the present invention aims to improve injection moldability and extrusion semi-processing (rod, plate) moldability of the polymer composition to facilitate application in the corresponding processing field.

### Solution to Problem

In order to achieve the above-described objects of the present invention and realize the characteristic effects of the present invention described below, the characteristic configuration of the present invention is as follows.

According to the present invention, there is provided a polymer composition including a liquid crystal polymer (LCP), an inorganic nucleating agent, a reinforcing agent, and a filler in polyaryletherketone (PAEK).

In this case, a weight ratio of the polyaryletherketone (PAEK) to the LCP is 95-50:5-50. In this case, the polyaryletherketone (PAEK) is preferably polyetherketoneketone (PEKK).

The LCD according to the present invention may include at least one selected from the group consisting of liquid crystal polyester, liquid crystal polyester amide, liquid crystal polyester ether, liquid crystal polyester carbonate, and liquid crystal polyamide.

The inorganic nucleating agent according to the present invention may include at least one selected from the group consisting of silica, talc, clay, alumina, mica, zirconia, titania, tin oxide, tin indium oxide, antimony tin oxide, calcium carbonate, kaolin, graphite, wollastocoat, wollastonite, dolomite, bauxite, and zeolite.

The reinforcing agent according to the present invention may include at least one selected from the group consisting of carbon fiber, glass fiber, ceramic fiber, boron fiber, glass bead, and glass bubble.

The filler according to the present invention may include at least one selected from the group consisting of carbon filler, carbon nanotubes, alumina hollow filler, silica hollow filler, glass hollow filler, wollastonite, and wollastocoat.

In addition, the polymer composition according to the present invention may further include at least one selected from the group consisting of an organic nucleating agent, a polymer-type nucleating agent, an organic tin compound, an organic titanium compound, alkali or alkaline earth metal salts of carboxylic acid, and inorganic acid salts as needed.

A weight average molecular weight of the polymer composition according to the present invention is 30,000 to 80,000.

On the other hand, there is provided a method for preparing a polymer composition, the method including: mixing a liquid crystal polymer (LCP), an inorganic nucleating agent, a reinforcing agent, and a filler with polyaryletherketone (PAEK) by using a mixing means; and performing kneading and extrusion thereon by a kneading extrusion means.

In this case, a weight ratio of the polyaryletherketone (PAEK) to the LCP, preferably, a weight ratio of polyetherketoneketone (PEKK) to the LCP is 95-50:5-50.

An embodiment of the mixing means according to the present invention may be at least one selected from a ribbon blender, a V-shaped blender, and a Henschel mixer, but the present invention is not limited thereto.

In addition, the kneading extrusion means may be at least one selected from an extruder, a Brabender Plasaticorder, a mixing roll, and a kneader, but the present invention is not limited thereto.

The mixing is performed by rotating and stirring for 1-10 minutes at 100-3,000 rpm at room temperature, and the kneading extrusion is performed at 250-400° C. and 50-500 rpm of a screw.

### Advantageous Effects of Disclosure

According to the present invention, there is an effect of providing a polyaryletherketone (PAEK) with an improved crystallization rate, and preferably, providing a polyetherketoneketone (PEKK) polymer composition with an improved crystallization rate.

Therefore, a polymer composition with an improved crystallization rate may be provided, thereby improving molding processability and further improving productivity, shape, dimensional stability, or the like of products.

In addition, due to the increase in crystallinity, it is possible to improve mechanical properties and heat resistance of the polymer composition.

Finally, since injection moldability and extrusion semi-processing (rod, plate) moldability of the polymer composition are improved, it is possible to provide an effect of facilitating application in the corresponding processing field.

### BRIEF DESCRIPTION OF DRAWING

FIG. 1 shows crystallinity of a polymer composition, which is prepared according to Example 1 of the present invention, with respect to time.

### BEST MODE

Reference is made to the accompanying drawing which shows, by way of illustration, specific embodiments in which the present invention may be practiced. The embodiments will be described in detail in such a manner that the present invention can be carried out by those of ordinary skill in the art. It should be understood that various embodiments of the present invention are different from each other, but need not be mutually exclusive. For example, certain shapes, structures, and features described herein may be implemented in other embodiments without departing from the spirit and scope of the present invention in connection with one embodiment. In addition, it will be understood that the locations or arrangement of individual components in the disclosed embodiments can be changed without departing from the spirit and scope of the present invention. Therefore, the following detailed description is not to be taken in a limiting sense, and the scope of the present invention is to be limited only by the appended claims and the entire scope of equivalents thereof, if properly explained. Like reference numerals in the drawing refer to the same or similar functions throughout the various aspects.

Hereinafter, preferred embodiments of the present invention will be described in detail with reference to the accompanying drawing, so that those of ordinary skill in the art can easily carry out the present invention.

The present invention provides a polymer composition with an improved crystallization rate and a method for preparing the same. The polymer with an improved crystallization rate includes polyarylketone (PAEK), and preferably, includes polyetherketoneketone (PEKK).

In particular, the present invention adopts a method for promoting crystal nucleation by including a liquid crystal polymer (LCP) so as to promote the crystallization rate, and further including organic and inorganic nucleating agents and a polymer-type nucleating agent.

There is provided a polymer composition including an LCP, an inorganic nucleating agent, a reinforcing agent, and a filler in polyaryletherketone (PAEK) according to the present invention.

In particular, the polyaryletherketoneketone (PAEK) is preferably provided as polyetherketoneketone (PEKK).

Polyetherketoneketone is a polymer produced by chain polymerization of terephthaloyl represented by chemical structure 1 and isophthaloyl represented by chemical structure 2, and characteristics of polyetherketoneketone are determined by the ratio of terephthaloyl to isophthaloyl. Terephthaloyl moiety is linear and rigid, and isophthaloyl moiety gives structural diversity due to its curved structure. Isophthaloyl affects flexibility, fluidity, and crystallization properties of polymer chains.

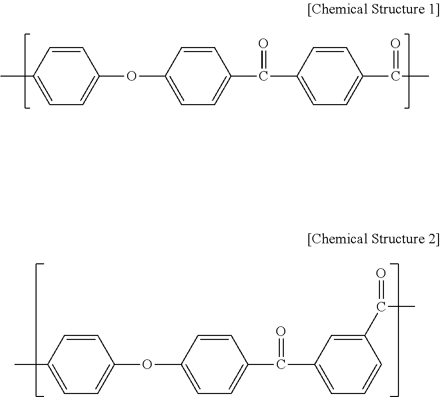

In particular, the isophthaloyl moiety increases flexibility or fluidity, but shows a low crystallization rate. Due to this, there is a problem in that the molding time increases during processing.

Therefore, in order to solve this problem, the present invention provides a method that includes an LCP polymer so as to improve the crystallization rate and includes organic and inorganic nucleating agents so as to promote crystal nucleation.

The LCP refers to a melt processable polymer having a property of forming an optically anisotropic melt phase. Due to a molten liquid crystallinity and a hard molecular skeleton, liquid crystallinity is improved when melted during processing, and molecular chains are oriented in stretch shear or the like. In addition, it is possible to provide a molded article having excellent fluidity and improved mechanical properties. That is, the resin including the LCP can provide chemical resistance, heat resistance, high strength, and excellent dimensional stability due to a hard molecular skeleton and excellent fluidity during molding, and thus, has a useful advantage as a high-performance engineering plastic resin.

The LCP according to the present invention may include liquid crystal polyester, liquid crystal polyester amide, liquid crystal polyester ether, liquid crystal polyester carbonate, and liquid crystal polyamide, but is not limited thereto. The type of the liquid crystal resin is not particularly limited, but liquid crystal polyester and liquid crystal polyester amide may be preferably provided. More preferably, when liquid crystal aromatic polyester or liquid crystal aromatic polyester amide is provided, it is advantageous in heat resistance and mechanical properties.

However, it is preferable to supplement the liquid crystal polymer by including a filler, a reinforcing agent, or the like due to characteristics having anisotropy, which is the difference in shrinkage with respect to vertical and horizontal. Therefore, the present invention can significantly increase the crystallization rate of the polyetherketoneketone polymer composition by including the LCP polymer, which is a liquid crystal polymer having molten liquid crystallinity, thereby improving injection processability.

More specifically, a weight ratio of the polyaryletherketone (PAEK) to the LCP, preferably, a weight ratio of the polyetherketoneketone (PEKK) to the LCP is 90-50:10-50. More preferably, the weight ratio is 95-50:5-50. When the proportion of the LCP is 5 or less, or when the proportion of the LCP is greater than 50, there is a problem in that the crystallization rate decreases. Therefore, the above range is most preferable.

That is, since the polyetherketoneketone (PEKK) includes the LCP polymer composition, it is possible to solve a problem of having a low crystallization rate due to the influence of the isophthaloyl moiety of the polyetherketoneketone. Also, it is possible to improve the crystallization rate while increasing crystallinity, thereby reducing a total cycle time in an injection molding process. Furthermore, since organic and inorganic nucleating agents and a polymer-type nucleating agent are included, crystal nucleation can be promoted and crystallinity can be further improved. This can shorten the cycle time of the entire process and competitiveness can be obtained, as compared to other general-purpose resins.

The inorganic nucleating agent according to the present invention may include at least one selected from the group consisting of silica, talc, clay, alumina, mica, zirconia, titania, tin oxide, tin indium oxide, antimony tin oxide, calcium carbonate, kaolin, graphite, wollastocoat, wollastonite, dolomite, bauxite, and zeolite. The inorganic nucleating agent refers to inorganic particles having a diameter of 1 μm or more, and preferably 2-10 μm, in a weight average size. The inorganic nuclearating agent is included in an amount of 0.1-10 parts by weight, and preferably 1-5 parts by weight, based on the total parts by weight of the polymer composition. In the above range, a desired effect can be most preferably provided when considering the economic cost and the promotion of crystal nucleation.

The reinforcing agent according to the present invention may include at least one selected from the group consisting of carbon fiber, glass fiber, ceramic fiber, boron fiber, glass bead, and glass bubble. The reinforcing agent is included in an amount of 1-15 parts by weight, and preferably 5-10 parts by weight, based on the total parts by weight of the polymer composition. When the amount of the reinforcing agent is greater than 20 parts by weight, it is difficult to process, the interfacial adhesion between the polymer and the reinforcing agent is lowered, resulting in a deterioration in mechanical properties. Therefore, the above range is preferable.

The filler according to the present invention may include at least one selected from the group consisting of carbon filler, carbon nanotubes, alumina hollow filler, silica hollow filler, glass hollow filler, wollastonite, and wollastocoat. The filler used in the present invention is not limited, but the filler may be used by treating a coupling agent in order to increase adhesion with other polymer resins. For example, soda-lime borosilicate glass including boron oxide, sodium oxide, calcium oxide, etc. may be used. Soda-lime borosilicate glass may be used alone, or more than one type may be used, but the present invention is not limited thereto. In addition, the filler may be used in an amount of 1-20 parts by weight, and preferably 5-15 parts by weight, based on the total parts by weight of the polymer composition. When the amount of the filler is less than 5 parts by weight, the weight reduction effect is insignificant, and when the amount of the filler is greater than 15 parts by weight, it is difficult to improve strength and molding due to crushing caused by collision between fillers.

The polymer composition according to the present invention may further include at least one selected from the group consisting of an organic nucleating agent, a polymer-type nucleating agent, an organic tin compound, an organic titanium compound, alkali or alkaline earth metal salts of carboxylic acid, and inorganic acid salts, as needed.

The organic nucleating agent may include at least one selected from the group consisting of sodium montanate, sodium carboxylate salt, sodium benzoate, sodium chlorobenzoate, monocarboxylic acid, carboxylic acid salt, dye (pigment), calcium stearate, and metal phosphate salt. Preferably, sodium montanate may be provided, but the present invention is not limited thereto. In addition, the organic nucleating agent may be included in an amount of 0.1-3 parts by weight based on the total parts by weight of the polymer composition. In the above range, it can help to improve the crystallization rate by forming crystal nuclei without deterioration of mechanical properties.

The polymer-type nucleating agent may include at least one selected from ethylene acrylic ester copolymer and metallocene polyethylene wax. When the polymer-type nucleating agent is included, the polymer-type nucleating agent may be included in an amount of 0.1-3 parts by weight based on the total parts by weight of the polymer composition. In this case, it can help to improve the crystallization rate by forming crystal nuclei in the role of the nucleating agent.

As the organic tin compound, diaryl tin oxide may be provided as dialkyl tin oxide, and dibutyl tin oxide may be provided as dialkyl tin oxide.

As the organic titanium compound, alkoxy titanium silicate, titanium alkoxide, or the like may be provided. As the alkali or alkaline earth metal salts of carboxylic acid, for example, potassium acetate, magnesium acetate, sodium acetate, or the like may be provided. As the inorganic acid salts, for example, potassium sulfate may be provided.

In addition, in the polymer composition according to the present invention, a heat stabilizer, an ultraviolet (UV) stabilizer, a UV blocker, a lubricant, a release agent, a coupling agent, or the like may be added as needed, but the present invention is not limited thereto.

A weight average molecular weight of the polymer composition according to the present invention is 30,000 to 80,000. In addition, the molecular weight may be measured through GPC analysis.

On the other hand, the present invention provides a method for preparing a polymer composition, which includes mixing an LCP, an inorganic nucleating agent, a reinforcing agent, and a filler with polyaryletherketone (PAEK) by using a mixing means, and performing kneading and extrusion thereon by a kneading extrusion means.

In this case, a weight ratio of the polyaryletherketone (PAEK) to the LCP, preferably, a weight ratio of the polyetherketoneketone (PEKK) to the LCP is 90-50:10-50. When the proportion of the LCP is 10 or less, there is a problem in that the crystallization rate decreases. On the other hand, when the proportion of the LCP is greater than 50, there is a problem in that the crystallization rate decreases. Therefore, the above range is most preferable.

An embodiment of the mixing means according to the present invention may be at least one selected from a ribbon blender, a V-shaped blender, and a Henschel mixer, but the present invention is not limited thereto.

The polymer composition is appropriately pre-mixed by using the mixing means, and the preparation thereof is possible by a process such as kneading and melt-kneading through a kneading extrusion means.

An embodiment of the kneading extrusion means according to the present invention may be at least one selected from an extruder, a Brabender Plasaticorder, a mixing roll, and a kneader, but the present invention is not limited thereto.

The kneading extrusion means provided in the process of preparing the polymer composition may preferably use an extruder. More preferably, a melt extruder may be provided. The process may be performed by optimizing process conditions according to various raw materials to be input in a melting process. In the melting process, a melting temperature may be 200-400° C., and preferably 310-380° C. At this time, a melt flow index is about 10 to 40. An analysis method is Melt Index, and the unit is g/10 min.

In addition, as an embodiment of the extruder, single-screw, twin-screw, and multi-screw extruders may be provided. Preferably, a twin-screw extruder is provided. In this case, a kneading property is excellent.

The mixing is carried out by rotating and stirring for 1-10 minutes at 1,000-3,000 rpm at room temperature. When the rotating and the stirring are performed within the above range, resin molecules of the polymer composition are loosened and entangled with each other to provide a sufficiently kneaded polymer composition. The kneading extrusion is performed at 250-400° C. and 50-500 rpm of a screw. When the kneading extrusion is carried out in the above range, the kneading extrusion occurs quickly and the polymer composition is not decomposed, thereby achieving effective kneading extrusion.

The shape of the polymer composition with an improved crystallization rate, which is prepared by the method for preparing the polymer composition is not particularly limited. For example, the shapes such as pellets, strands, sheets, flat plates, or pellets may be provided.

In addition, a part material prepared by including the polymer composition according to the present invention is provided. In one embodiment, the part material is selected from the group consisting of a vehicle material, an electronic device material, an industrial material, a construction engineering material, a 3D printer material, a textile material, a cladding material, a machine tool material, a medical material, an aviation material, a photovoltaic material, a battery material, a sports material, a household appliance material, a household material, and a cosmetic material. However, this is only an example, and the present invention is not limited thereto.

Hereinafter, the structure and operation of the present invention will be described in more detail with reference to preferred examples of the present invention. However, these examples are shown by way of illustration and should not be construed as limiting the present invention in any sense.

Since contents not described herein can be sufficiently technically inferred by those of ordinary skill in the art, descriptions thereof will be omitted.

### EXAMPLES

### Example 1

A mixed composition was prepared with a polymer composition including 95 parts by weight of K7500 (polyetherketoneketone (PEKK)) available from Polymics and 5 parts by weight of S475 (LCP) available from Polyplastic by using a 19-mm twin-screw extruder with L/D=40/1 at 380° C.

The polymer composition was prepared as pellets by additionally adding 3 parts by weight of an inorganic nucleating agent, 7 parts by weight of a reinforcing agent, 10 parts by weight of a filler to the mixture composition. A sample prepared as pellets was prepared as an analytical specimen by injection. A tensile strength specimen conforming to the ISO 527 standard was fabricated, and a mechanical property test was performed thereon. A heat deflection temperature specimen conforming to the ISO 75-1/-2 standard was fabricated, and a thermal property test was performed thereon.

### Example 2

The same as Example 1 was performed except that 90 parts by weight of K7500 (polyetherketoneketone (PEKK)) available from Polymics and 10 parts by weight of S475 (LCP) available from Polyplastic were included.

### Example 3

The same as Example 1 was performed except that 80 parts by weight of K7500 (polyetherketoneketone (PEKK)) available from Polymics and 20 parts by weight of S475 (LCP) available from Polyplastic were included.

### Example 4

The same as Example 1 was performed except that 50 parts by weight of K7500 (polyetherketoneketone (PEKK)) available from Polymics and 50 parts by weight of S475 (LCP) available from Polyplastic were included.

### Comparative Example 1

A polymer composition was prepared with K7500 (polyetherketoneketone (PEKK)) neat resin commercially available from Polymics.

### Comparative Example 2

The same as Comparative Example 1 was performed except that 10 parts by weight of K7500 (polyetherketoneketone (PEKK)) commercially available from Polymics and 90 parts by weight of S475 (LCP) available from Polyplastic were included.

### Experimental Example 1 (Crystallization Rate)

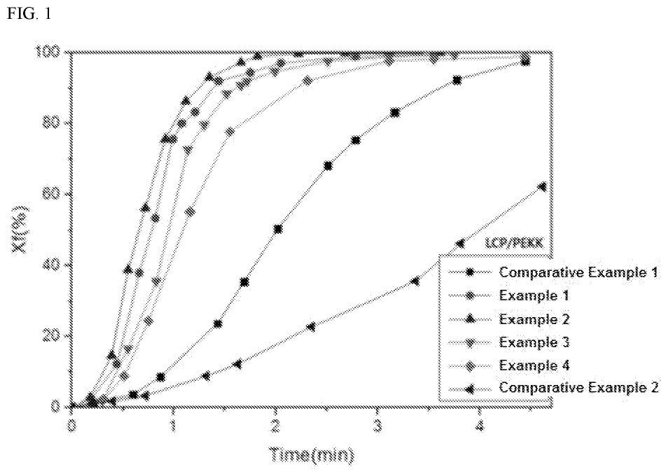

Crystallinity of each of the polymer compositions according to Examples and Comparative Examples was measured by using DSC, and the results thereof are shown in FIG. 1. A measuring equipment was Perkin Elmer DSC 8000. Perkin Elmer DSC 8000 is a heat flow method and is capable of rapid cooling, that is, quenching. It is suitable for an isothermal crystallization kinetics experiment, which observes a crystal formation process at a constant temperature after quenching.

### Experimental Example 2 (Tensile Strength) UTM

A tensile strength of each of the polymer compositions according to Examples and Comparative Examples was measured by using UTM, and the results thereof are shown in Table. 1. A measuring equipment was 5967 (30 kN) available from Instron, and the measurement was performed at 5 mm/min (23° C.) according to a test method ISO 527.

### Experimental Example 3 (Heat Deflection Temperature) HDT

A heat deflection temperature of each of the polymer compositions according to Examples and Comparative Examples was measured by using HDT, and the results thereof are shown in Table. 1. An equipment was CEAST HV6 available from Instron, a test method was based on ISO 75-1/-2, and a temperature range was provided from room temperature to 300° C. In addition, silicone oil was provided as a heating medium. A viscosity was 100 cSt, and a test method A used a nominal surface stress of 1.8 Mpa.

TABLE 1

| | 0/100 | 10/90 | 20/80 | 30/70 | 50/50 | 90/10 |
|---|---|---|---|---|---|---|
| | Comparative | Example | Example | Example | Example | Comparative |
| LCP/PEKK | Example 1 | 1 | 2 | 3 | 4 | Example 2 |
| Tensile strength | 105 | 113 | 120 | 137 | 142 | 175 |
| (Mpa) | | | | | | |
| Heat deflection | 172 | 178 | 185 | 192 | 206 | 232 |
| temperature (° C.) | | | | | | |

As shown in Table 1, the tensile strength and the heat deflection temperature of Examples, which are polymer compositions according to the present invention, can be confirmed. Therefore, it was confirmed that the mechanical properties and thermal properties were different depending on the content of polyaryletherketone (PAEK), preferably polyetherketoneketone and LCP.

In addition, as can be seen from the results of FIG. 1, the polymer composition according to the present invention has improved crystallinity and crystallization rate. In particular, it was confirmed that the crystallization rate was significantly improved in Examples, as compared to Comparative Examples.

Therefore, since the polymer composition with an improved crystallization rate according to the present invention significantly improves the crystallization rate, it can be confirmed that the molding processability is improved, and the mechanical properties and heat resistance of the polymer composition are improved due to the increase in crystallinity. Finally, since injection moldability and extrusion semi-processing (rod, plate) moldability of the polymer composition are improved, it is possible to provide an effect of facilitating application in the corresponding processing field.

While the present invention has been described by particular matters such as specific components and limited embodiments and drawings, this is provided only for helping the comprehensive understanding of the present invention. The present invention is not limited to the above-described embodiments, and it will be understood by those of ordinary skill in the art that various modifications and variations can be made thereto without departing from the scope of the present invention.

Therefore, it will be understood that the spirit of the present invention should not be limited to the above-described embodiments and the claims and all equivalent modifications fall within the scope of the present invention.

1: A polymer composition comprising a liquid crystal polymer (LCP), an inorganic nucleating agent, a reinforcing agent, and a filler in polyaryletherketone (PAEK).

2: The polymer composition of claim 1, wherein a weight ratio of the polyaryletherketone (PAEK) to the LCP is 95-50:5-50.

3: The polymer composition of claim 1, wherein the polyaryletherketone (PAEK) is polyetherketoneketone (PEKK).

4: The polymer composition of claim 1, wherein the LCD comprises at least one selected from the group consisting of liquid crystal polyester, liquid crystal polyester amide, liquid crystal polyester ether, liquid crystal polyester carbonate, and liquid crystal polyamide.

5: The polymer composition of claim 1, wherein the polymer composition comprises 0.1-10 parts by weight of the inorganic nuclearing agent, 1-15 parts by weight of the reinforcing agent, and 1-20 parts by weight of the filler based on a total parts by weight of the polymer composition.

6: The polyetherketoneketone (PEKK) polymer composition of claim 1, wherein the inorganic nucleating agent comprises at least one selected from the group consisting of silica, talc, clay, alumina, mica, zirconia, titania, tin oxide, tin indium oxide, antimony tin oxide, calcium carbonate, kaolin, graphite, wollastocoat, wollastonite, dolomite, bauxite, and zeolite.

7: The polymer composition of claim 1, wherein the reinforcing agent comprises at least one selected from the group consisting of carbon fiber, glass fiber, ceramic fiber, boron fiber, glass bead, and glass bubble.

8: The polymer composition of claim 1, wherein the filler comprises at least one selected from the group consisting of carbon filler, carbon nanotubes, alumina hollow filler, silica hollow filler, glass hollow filler, wollastonite, and wollastocoat.

9: The polymer composition of claim 1, further comprising at least one selected from the group consisting of an organic nucleating agent, a polymer-type nucleating agent, an organic tin compound, an organic titanium compound, alkali or alkaline earth metal salts of carboxylic acid, and inorganic acid salts.

10: The polymer composition of claim 1, wherein a weight average molecular weight of the polymer composition is 30,000 to 80,000.

11: A part material prepared by including the polymer composition according to claim 1.

12: The part material of claim 11, wherein the part material is at least one selected from a vehicle material, an electronic device material, an industrial material, a construction engineering material, a 3D printer material, a textile material, a cladding material, a machine tool material, a medical material, an aviation material, a photovoltaic material, a battery material, a sports material, a household appliance material, a household material, and a cosmetic material.

13: A method for preparing a polymer composition, the method comprising:
mixing a liquid crystal polymer (LCP), an inorganic nucleating agent, a reinforcing agent, and a filler with polyaryletherketone (PAEK) by using a mixing means; and
performing kneading and extrusion thereon by a kneading extrusion means.

14: The method of claim 13, wherein a weight ratio of the polyaryletherketone (PAEK) to the LCP is 95-50:5-50.

15: The method of claim 13, wherein the polyaryletherketone (PAEK) is polyetherketoneketone (PEKK).

16: The method of claim 13, wherein the mixing means is at least one selected from a ribbon blender, a V-shaped blender, and a Henschel mixer.

17: The method of claim 13, wherein the kneading extrusion means is at least one selected from an extruder, a Brabender Plasaticorder, a mixing roll, and a kneader.

18: The method of claim 13, wherein the mixing is performed by rotating and stirring for 1-10 minutes at 100-3,000 rpm at room temperature.

19: The method of claim 13, wherein the kneading extrusion is performed at 250-400° C. and 50-500 rpm of a screw.
